(19) United States
(12) Patent Application Publication
(10) Pub. No.: US 2007/0013819 A1
(43) Pub. Date: Jan. 18, 2007

(54) Touch screen display panels and devices

(75) Inventors: Sang-Jin Pak, Yongin-si (KR); Myung-Woo Lee, Seoul (KR); Man-Seung Cho, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/485,845

(22) Filed: Jul. 12, 2006

(30) Foreign Application Priority Data
Jul. 12, 2005 (KR) 2005-62477

(51) Int. Cl. G02F 1/1335

(52) U.S. Cl. 349/12

(57) ABSTRACT

A display panel includes a lower substrate, an upper substrate and a liquid crystal layer interposed therebetween. The lower substrate is divided into a display region for displaying an image and an adjacent peripheral region, and includes a plurality of pixel parts, a plurality of photo sensing parts, and a reflection preventing layer. The pixel parts are disposed in the display region for forming an image. The photo sensing parts are disposed in the display region for detecting the location of an object placed on or immediately adjacent to a surface of the display panel. The upper substrate faces the lower substrate, and includes a black matrix corresponding to the peripheral region. The reflection preventing layer is disposed in the peripheral region to prevent the black matrix from reflecting light back onto the photo sensing parts and thereby adversely affecting their operation.

### RELATED APPLICATIONS

This application claims priority of Korean Patent Application No. 2005-62477, filed Jul. 12, 2005, the disclosure of which is incorporated herein by reference in its entirety.

### BACKGROUND

1. Technical Field

The present invention relates to display panels, in general, and in particular, to a liquid crystal display (“LCD”) panel having an integrated touch screen with photo sensors, and a display device incorporating the same.

2. Related Art

A conventional touch screen panel, in general, is an input device disposed on a display panel so that data can be input to a system including the panel using an object, such as a finger, stylus, pen, or the like. A typical touch screen panel includes opposing first and second substrates, with first and second transparent electrodes respectively disposed thereon.

If such conventional touch screen panels are simply attached to an exterior surface of a display panel, they can adversely affect the optical characteristics of the panel and undesirably increase its thickness. To avoid these problems, the touch screen is often internally integrated into the display panel.

Display panels often include a photo sensor, comprising an amorphous silicon or polysilicon thin film transistor (“TFT”) formed thereon. Light generated from a backlight assembly is reflected from an object disposed on or immediately adjacent to a front surface of the display, and the photo sensor senses the reflected light to detect the location of the object. That is, the photo sensor senses the light reflected from the object and generates a signal corresponding to its location on the front surface of the panel, and the display device senses the signal and generates data corresponding to the location of the object.

The display panel is divided into a display region and a peripheral region surrounding the display region. The display region includes a plurality of pixels for forming an image, and a plurality of uniformly arranged photo sensors for detecting object location. In such an arrangement, the photo sensor sensing signal corresponding to the central portion of the display region is constant.

However, the sensing signal corresponding to the peripheral portion of the display region is adversely affected by noise that is caused by light being reflected back onto the photo sensors by a black matrix located in the peripheral region of the display, thereby deteriorating the quality of the location data generated by the photo sensors.

### SUMMARY

In accordance with the present invention, there is provided a display panel integrated with a touch screen having a photo sensor, and a display device incorporating the display panel, that overcomes the above and other problems of prior art display panels.

In accordance with one exemplary embodiment thereof, the novel display panel, which may be of either a pure transmissive or a reflective-transmissive type, includes a lower substrate, a corresponding upper substrate, and a liquid crystal layer interposed between the lower and upper substrates. The upper substrate faces the lower substrate and includes a black matrix corresponding to a peripheral region of the lower substrate.

The lower substrate is divided into a display region for displaying an image, and a peripheral region disposed adjacent to the display region. The lower substrate includes a plurality of pixel parts, a plurality of photo sensing parts, and a reflection preventing layer. The pixel parts are disposed in the display region for displaying the image. The photo sensing parts are disposed in the display region for detecting the location of an object disposed on or immediately adjacent to an upper surface of the display panel. The reflection preventing layer is disposed in the peripheral region.

The pixel parts may include a gate line, a data line, a first switching element, and a transparent electrode. The data line crosses the data line but is electrically insulated from it. The first switching element is electrically coupled to the gate line and the data line. The transparent electrode is electrically coupled to the first switching element. In an exemplary reflective-transmissive embodiment, the lower substrate may further include a reflection electrode electrically coupled to the transparent electrode. The reflection electrode includes a transmission window through which light is transmitted. The reflection preventing layer may include substantially the same material, and be formed in substantially the same layer, as the reflection electrode, for manufacturing simplicity.

In another exemplary embodiment, the peripheral region may further include first, second and third peripheral portions, with an input terminal of the data line being disposed on the first peripheral portion, an input terminal of the gate line being disposed on the second peripheral portion, and the third peripheral portion being disposed adjacent to the first and second peripheral portions.

The reflection preventing layer in the first peripheral portion can comprise substantially the same material, and be formed in substantially the same layer, as the gate line. The reflection preventing layer in the second peripheral portion can comprise substantially the same material, and be formed in substantially the same layer, as the data line. The reflection preventing layer in the third peripheral portion can comprise substantially the same material, and be formed in substantially the same layer, as either one of the gate or data lines, again for reasons of manufacturing simplicity.

The photo sensing parts can include first and second sensing lines, and second and third switching elements. The second sensing line crosses but is electrically insulated from the first sensing line. The second switching element is electrically coupled to the first sensing line to generate a sensing signal in response to light being incident thereon. The third switching element applies the sensing signal from the second switching element to the second sensing line.

A second exemplary embodiment of a display device in accordance with the present invention includes a backlight assembly and a display panel. The backlight assembly generates a uniform field of light. The display panel is disposed in above of the backlight assembly to display an image generated by selectively filtering the light generated by the backlight assembly.

The display panel includes a lower substrate, a corresponding upper substrate facing the lower substrate, and a liquid crystal layer interposed between the lower and upper substrates. The lower substrate is divided into a display region for displaying the image, and a peripheral region disposed adjacent to the display region. The lower substrate includes a plurality of pixel parts, a plurality of photo sensing parts, and a reflection preventing layer. The pixel parts are disposed in the display region for displaying the image. The photo sensing parts are disposed in the display region for detecting the location of an object on the display panel. The upper substrate includes a black matrix corresponding to the peripheral region of the lower substrate. The reflection preventing layer prevents the black matrix from reflecting light from the backlight back onto the photo sensing parts.

Thus, in accordance with the present invention, the light that is reflected from the black matrix of the upper substrate is not incident upon the photo sensing parts of the lower substrate, so that the ability of the photo sensing parts to sense location of objects accurately and reliably and to generate corresponding object location data is substantially improved.

### DESCRIPTION OF THE DRAWINGS

The above and many other features and advantages of the present invention will become more apparent by a consideration of the detailed description below of some exemplary embodiments thereof, particularly if made with reference to the accompanying drawings, in which:

FIG. 1 is a cross-sectional view of an exemplary embodiment of a display device in accordance with the present invention;

FIG. 2 is a cross-sectional view of the exemplary display device of FIG. 1;

FIG. 3 is a top plan view of the lower substrate of the exemplary device of FIG. 2;

FIG. 4 is a top plan view of another exemplary embodiment of a display panel in accordance with the present invention;

FIG. 5 is a cross-sectional view taken along the section lines I-I′ of FIG. 4; and,

FIG. 6 is a cross-sectional view taken along the section lines II-II′ of FIG. 4.

### DETAILED DESCRIPTION

The invention is described below in detail with reference to the accompanying drawings, wherein like reference numerals are used to identify like elements illustrated in one or more of the figures thereof, and in which exemplary embodiments of the invention are shown. This invention may, however, be embodied in many different forms and should not be construed as limited to the particular embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It should be understood that, when an element or layer is referred to herein as being “disposed on”, “connected to” or “coupled to” another element or layer, it can be directly disposed on, connected or coupled to the other element or layer, or alternatively, that intervening elements or layers may be present. In contrast, when an element is referred to as being “directly disposed on,” “directly connected to” or “directly coupled to” another element or layer, there are no intervening elements or layers present. In the figures, like numbers refer to like elements throughout. As used herein, the term “and/or” includes any and all combinations of one or more of the associated listed items.

It should further be understood that, although the terms first, second, third, and the like may be used herein to describe various elements, components, regions, layers and/or sections, these elements, components, regions, layers and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

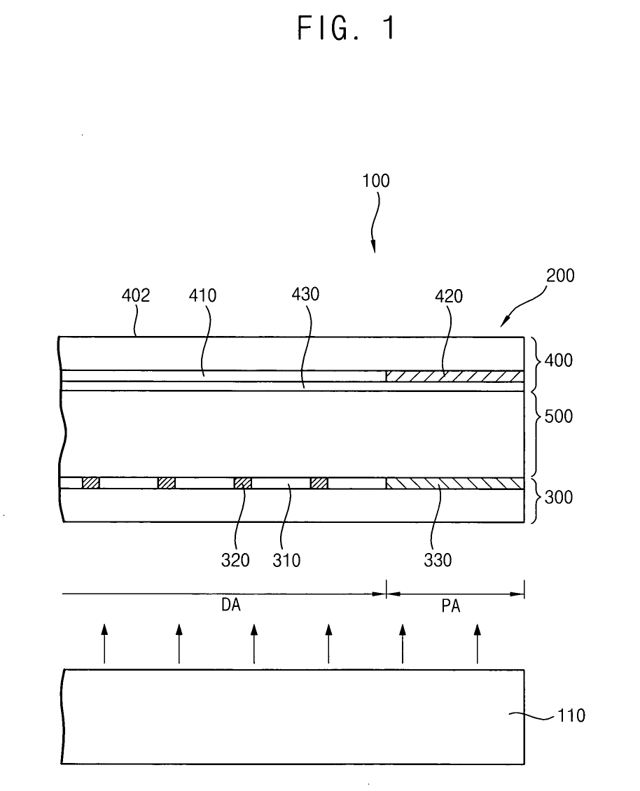

FIG. 1 is a cross-sectional view showing a display device in accordance with a first exemplary embodiment of the present invention. As illustrated, the exemplary display device 100 includes a backlight assembly 110 and a display panel 200. The backlight assembly 110 generates a uniform field of light, and is disposed below the display panel 200 to project the light through the display panel 200. The display panel 200 selectively filters the light from the backlight assembly 110 to form and display an image at an upper surface 402 of the panel. In the exemplary embodiments illustrated herein, the backlight assembly 110 and the display panel 200 are shown disposed horizontally, but as those of skill in art will appreciate, these components can also be arranged vertically to define a forward-facing display device suitable for mounting on, e.g., a wall, desktop or panel of displays.

As illustrated in FIG. 1, the display panel 200 includes a lower substrate 300, an upper substrate 400 corresponding in size to and overlying the lower substrate 300, and a liquid crystal layer 500 interposed between the lower and upper substrates 300 and 400.

The lower substrate 300 is divided into a display region DA and a peripheral region PA disposed adjacent to the display region DA. An image formed by the display is displayed in the display region DA but not in the peripheral region PA. The lower substrate 300 includes a plurality of pixel parts 310 and a plurality of photo sensing parts 320 respectively disposed in the display region DA. The pixel parts 310 display the image, and the sensing portions 320 sense the location of an object disposed on or immediately adjacent to the upper surface 402 of the display 200.

The pixel parts 310 and the photo sensing parts 320 are formed in the display region, and arranged in a two-dimensional matrix. To increase the response time of the panel 200, each of the photo sensing parts 320 are made smaller than the pixel parts 310. The number and location arrangement of the photo sensing parts 320 can, of course, be varied from the arrangement illustrated. For example, each of the pixel parts 310 can have three sub pixels, and each of the photo sensing parts 320 can correspond to one of the three sub pixels. Alternatively, each of the photo sensing parts 320 can correspond to one of every four or nine pixel parts 310.

The lower substrate 300 may further include a reflection preventing layer 330 disposed in the peripheral region PA. The reflection preventing layer 330 blocks light reflected from a black matrix 420 disposed on the upper substrate 400 so that the reflected light is not incident upon the photo sensing parts 320. For example, the reflection preventing layer 330 may comprise an opaque metal that blocks the reflected light.

The upper substrate 400 further includes a color filter layer 410 corresponding to the display region DA, and the black matrix 420, which corresponds to the peripheral region PA. The color filter layer 410 includes a plurality of color filters that form a color image from the light generated by the backlight assembly 110. For example, the color filter layer 410 includes a red color filter, a green color filter and a blue color filter corresponding to the pixel parts 310. The black matrix 420 is disposed on the upper substrate 400 to block light from the backlight assembly 110 that is incident on the peripheral region PA. Optionally, the black matrix 420 may be formed in the color filter layer 410.

The black matrix 420 can include any opaque material that blocks light. Examples of opaque materials that can be used for the black matrix 420 include chromium oxide, chromium, and the like. For example, the black matrix 420 can have a triple-layered structure that includes a chromium oxide layer, a chromium layer disposed on the chromium oxide layer, and a chromium oxide layer disposed on the chromium layer.

As illustrated in FIG. 1, The upper substrate 400 may further include a common electrode 430 disposed below the color filter layer 410. The common electrode 430 includes a transparent conductive material. Examples of the transparent conductive material that can be used for the common electrode 430 include indium tin oxide (ITO) or indium zinc oxide (IZO).

The liquid crystal layer 500 includes liquid crystal molecules that have electrical and optical anisotropy. The liquid crystal molecules are arranged in a predetermined direction. The arrangement of the liquid crystal molecules of the liquid crystal layer 500 is selectably variable in response to the application of an electric field thereto. The electric field is formed between the lower substrate 300 and the upper substrate 400.

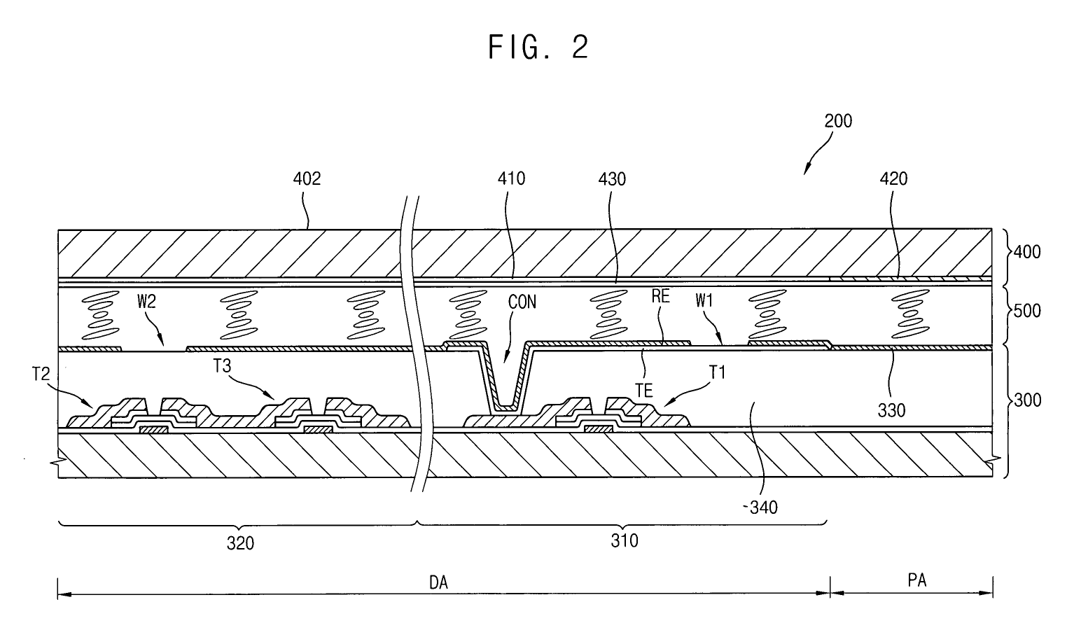

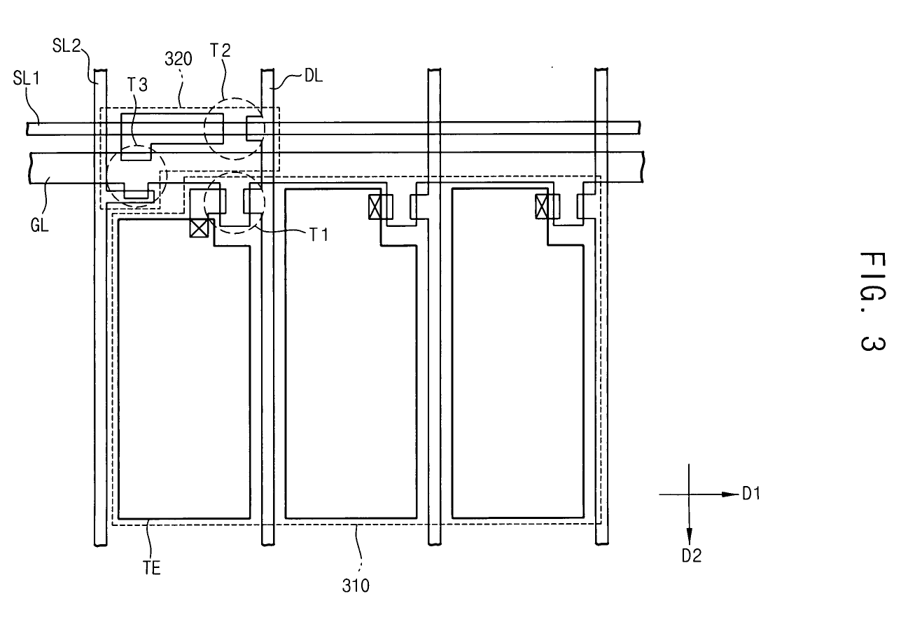

FIG. 2 is another cross-sectional view of the display device 200 of FIG. 1, and FIG. 3 is a top plan view of the lower substrate 300 thereof. As illustrated in FIGS. 2 and 3, the lower substrate 300 includes the pixel parts 310 for displaying an image, and the photo sensing parts 320 for sensing the location of the object. In the particular exemplary embodiment illustrated, each of the pixel parts 310, shown within a dashed outline, includes three sub pixels, and each of the photo sensing parts 320, shown within a second dashed outline, is disposed adjacent to one of the three sub pixels.

As illustrated in FIG. 3, the pixel parts 310 include gate lines GL, data lines DL, first switching elements T1 and transparent electrodes TE. The gate lines GL extend in a first direction D1. The data lines DL extend in a second direction D2 that is substantially perpendicular to the first direction D1. The data lines DL cross, but are electrically insulated from, the gate lines GL. The first switching elements T1 are electrically coupled to the gate lines GL and the data lines DL, and the transparent electrodes TE are electrically coupled to the first switching elements T1.

Each of the first switching elements T1 includes a gate electrode, a source electrode and a drain electrode. The gate electrode of the first switching element T1 is electrically coupled to one of the gate lines GL. The source electrode of the first switching element T1 is electrically coupled to one of the data lines DL. The drain electrode of the first switching element T1 is electrically coupled to one of the transparent electrodes TE. By way of example, each of the first switching elements T1 may comprise an amorphous silicon thin film transistor (TFT). Alternatively, each of the first switching elements T1 may comprise a polysilicon TFT.

With reference to FIG. 3, the photo sensing parts 320 include first sensing lines SL1, second sensing lines SL2, second switching elements T2, and third switching elements T3. The first sensing lines SL1 extend in the first direction D1. The second sensing lines SL2, which are electrically insulated from the first sensing lines SL1, extend in the second direction D2, and hence, cross either over or under the first sensing lines SL1. The second switching elements T2 are electrically connected to the first sensing lines SL to detect incident light. The third switching elements T3 are electrically connected to the second switching elements T2.

The first sensing lines SL1 are formed in substantially the same layer, i.e., at substantially the same vertical level, as the gate lines GL, but are spaced apart from the gate lines GL by a selected distance so that the first sensing lines SL1 are electrically insulated from the gate lines GL. The second sensing lines SL2 are formed in substantially the same layer as the data lines DL, but are likewise spaced apart from the data lines DL by a selected distance so that the second sensing lines SL2 are electrically insulated from the data lines DL.

Each of the second switching elements T2 is operative to generate an object location sensing signal based on light reflected from an object, such as a finger, stylus, pen, or the like, placed on or immediately adjacent to the upper surface 402 of the display and overlying adjacent ones of the sensing elements. That is, light generated by the backlight assembly 110 passes through the display panel 200 and is reflected by the object back to the sensing elements adjacent to the object. Each of the second switching elements T2 located adjacent to the object thus senses the reflected light incident upon itself and outputs a signal corresponding to the location of the object on the upper surface 402 display.

Each of the second switching elements T2 includes a gate electrode, a source electrode and a drain electrode. The gate electrode of the second switching element T2 is electrically coupled to one of the first sensing lines SL1. The source electrode of the second switching element T2 is electrically coupled to one of the data lines DL. The drain electrode of the second switching element T2 is electrically coupled to one of the third switching elements T3.

Each of the third switching elements T3 applies the location sensing signal generated by the second switching elements T2 to the second sensing line SL2. Each of the third switching elements T3 includes a gate electrode, a source electrode and a drain electrode. The gate electrode of the third switching element T3 is electrically coupled to one of the gate lines GL. The source electrode of the third switching element T3 is electrically coupled to the source electrode of the second switching element T2. The drain electrode of the third switching element T3 is electrically coupled to one of the second sensing lines SL2.

The second and third switching elements T2 and T3 are preferably formed by the same thin film processes used to form the first switching elements T1. For example, the first, second and third switching elements T1, T2 and T3 can comprise amorphous silicon TFTs. Alternatively, the first switching elements T1 can comprise polysilicon TFTs.

As illustrated in FIG. 2, an insulating layer 340 covers the first, second and third switching elements T1, T2 and T3, and has contact holes CON through which the drain electrodes of the first switching elements T1 are exposed. The transparent electrodes TE are disposed on the insulating layer 340 and electrically coupled to the drain electrodes of the first switching elements T1. The transparent electrodes TE comprise a transparent, electrically conductive material. Examples of transparent conductive materials that can be used for the transparent electrodes TE include indium tin oxide (ITO) or indium zinc oxide (IZO).

In the particular exemplary embodiment of FIGS. 2 and 3, the lower substrate 300 comprises a reflective-transmissive substrate incorporating a plurality of the transparent electrodes TE, as well as a plurality of reflection electrodes RE. Light originating externally of the panel 200 is reflected by the reflection electrodes RE back through the panel. The reflection electrodes RE are disposed over the pixel parts 310 and the photo sensing parts 320. Each of the reflection electrodes RE includes a transmission window W1 for partially exposing each of the transparent electrodes TE, and an opening window W2 for exposing each of the second switching elements T2. The reflection electrodes RE can comprise either a mono-layered structure or a double-layered structure. For example, the mono-layered structure may comprise an aluminum-neodymium layer, and the double layered structure can comprise an aluminum-neodymium layer and a molybdenum-tungsten layer.

As above, the reflection preventing layer 330 blocks the light that is reflected back from the black matrix 420 of the upper substrate 400 so that the reflected light is not incident upon the photo sensing parts 320 located adjacent to the peripheral region PA, thereby preventing any deterioration in their performance caused by such reflections.

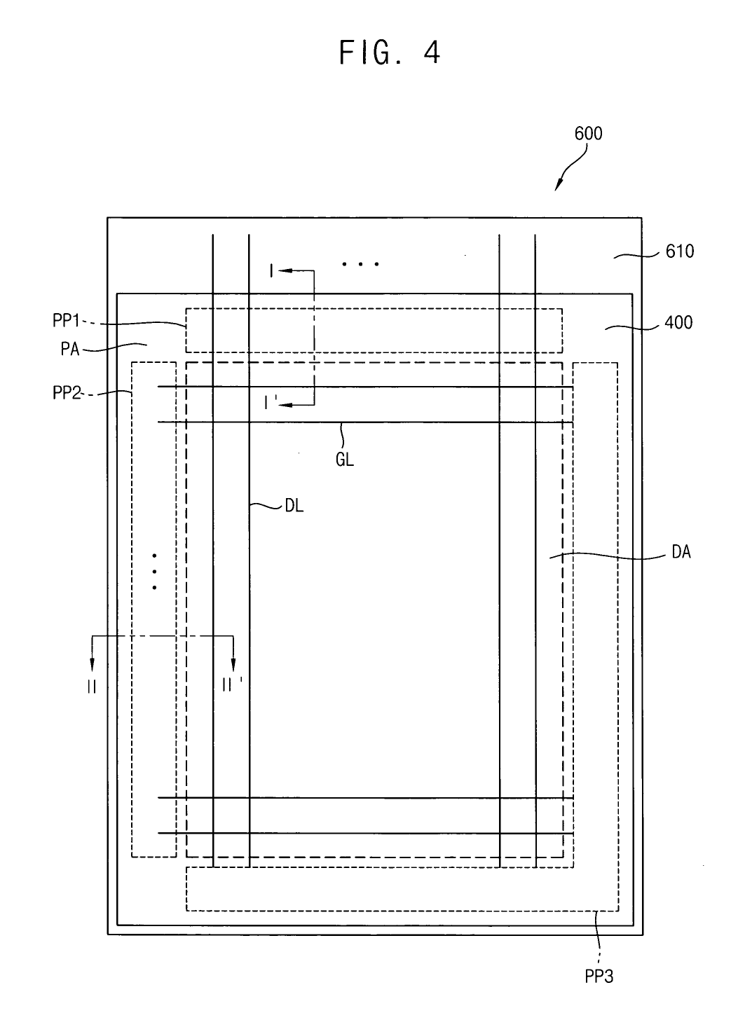

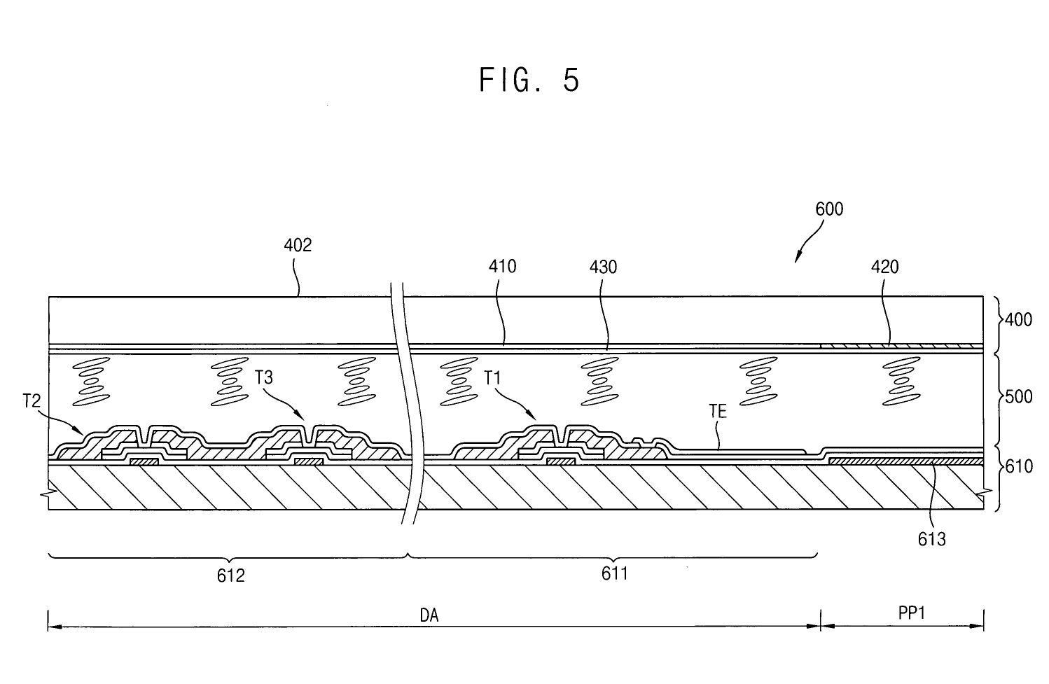

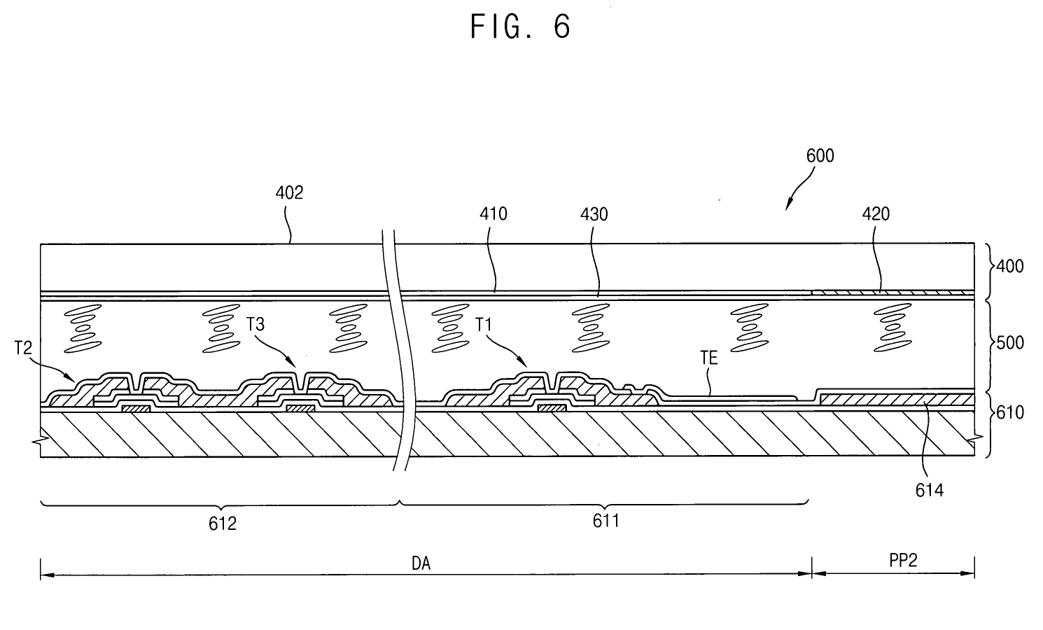

FIG. 4 is a top plan view of a second exemplary embodiment of a display panel in accordance with the present invention. FIG. 5 is a cross-sectional view taken along the lines I-I′ of FIG. 4, and FIG. 6 is a cross-sectional view taken along lines II-II′ therein. As may be seen by reference to these figures, the display apparatus of FIGS. 4-6 is substantially similar to the first exemplary embodiment of FIGS. 1-3 described above, except as relates to the lower substrate thereof. Therefore, the same reference numerals are used to refer to the same or like parts as those of FIGS. 1-3, and further discussion of these elements is omitted for brevity.

Referring to FIGS. 4 and 5, the display panel 600 includes a lower substrate 610, an upper substrate 400 corresponding in size to and disposed above the lower substrate 610, and a liquid crystal layer 500 interposed between the upper and lower substrates 400 and 610.

The lower substrate 610 is divided into a display region DA within which an image is displayed, and a peripheral region PA adjacent to the display region, in which no image is displayed. The peripheral region PA includes a first peripheral portion PPA, a second peripheral portion PP2, and a third peripheral portion PP3. Input terminals of data lines DL are disposed in the first peripheral portion PP1. Input terminals of gate lines GL are disposed in the second peripheral portion PP2. The third peripheral portion PP3 is disposed adjacent to the first and second peripheral portions PP1 and PP2.

The lower substrate 610 further includes a plurality of pixel parts 611 and a plurality of photo sensing parts 612 disposed in the display region DA. The pixel parts 611 display the image, and the sensing portions 612 sense the location of an object on the upper surface 402 of the display, as in the first exemplary embodiment 200 above. The pixel parts 611 and the photo sensing parts 612 are formed in the display region DA, and arranged in a two-dimensional matrix.

As may be seen by a comparison of the respective first and second exemplary embodiments 200 and 600, in the second exemplary embodiment 600 of FIGS. 4 and 5, the lower substrate 610 is a pure transmissive type substrate that does not include any reflection electrodes RE. The pixel parts and the photo sensing parts FIGS. 4 and 5 are substantially the same as those of FIGS. 1-3, except for the insulating layer and the lack of reflection electrodes. Therefore, further discussion of these elements is omitted for brevity.

The lower substrate 610 may further include a first reflection preventing layer 613 that is disposed in the first peripheral region PP1. The first reflection preventing layer 613 comprises substantially the same material, and is preferably formed in substantially the same layer, as the gate lines GL.

When the data lines DL are formed on a portion of the first peripheral portion PP1, the first reflection preventing layer 613 is formed on the remaining portion of the first peripheral portion PP1 so that the first reflection preventing layer 613 is spaced apart from the data lines DL. Therefore, the first reflection preventing layer 613 is disposed to block the light reflected from the black matrix 420 of the upper substrate 400 so that the reflected light is not incident upon the photo sensing parts 612 located adjacent to the first peripheral portion PP1, and therefore cannot adversely affect their function.

Referring to FIGS. 4 and 6, the lower substrate 610 may further include a second reflection preventing layer 614 disposed in the second peripheral region PP2. The second reflection preventing layer 614 can comprise substantially the same material, and may be formed in substantially the same layer, as the data lines DL.

When the gate lines GL are formed on a portion of the second peripheral portion PP2, the second reflection preventing layer 614 is disposed on the remaining portion of the second peripheral portion PP2 such that it is spaced apart from the gate lines GL. The second reflection preventing layer 614 is thus disposed to block the light reflected from the black matrix 420 of the upper substrate 400 so that the reflected light is not incident upon the photo sensing parts 612 adjacent to the second peripheral portion PP2.

The lower substrate 610 may further include a third reflection preventing layer (not illustrated) that is disposed in the third peripheral region PP3. The third reflection preventing layer may comprise substantially the same material, and can be formed in substantially the same layer, as either one of the data lines DL or the gate lines GL. In such an embodiment, the gate lines GL and DL are omitted from the third peripheral portion PP3 so that the third reflection preventing layer may be formed simultaneously with the gate or data lines GL or DL. The third reflection preventing layer acts to block the light reflected from the black matrix 420 of the upper substrate 400 so that the light is not incident upon the photo sensing parts 612 located adjacent to the third peripheral portion PP3.

In accordance with the present invention, the light that is reflected from the black matrix of the upper substrate is prevented from reflecting upon the photo sensing parts so that the likelihood of false or erroneous readings of the photo sensing parts caused thereby is substantially reduced, and the reliability and accuracy of the object's location data is thereby enhanced.

When the lower substrate is a reflective-transmissive type of substrate having a reflection electrode RE, as in the first exemplary embodiment 200 described above, the reflection preventing layer may be formed in the peripheral region of the lower substrate simultaneously with the reflection electrode RE so that light reflected by the black matrix will not reflect onto the photo sensing parts, and the manufacturing process of the lower substrate is also simplified.

In addition, when the lower substrate is of the transmissive type of substrate, i.e., one not having any reflection electrodes RE, as in the second exemplary embodiment 600 described above, the reflection preventing layer may be simultaneously with the gate lines GL or the data lines DL, so that light reflected from the black matrix will not reflect onto the photo sensing parts, and the manufacturing process of the lower substrate is also simplified.

By now, those of some skill in this art will appreciate that many modifications, substitutions and variations can be made in and to the materials, apparatus, configurations and methods of the display panels of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. A display panel, comprising:
a lower substrate divided into a display region for displaying an image and a peripheral region disposed adjacent to the display region, the lower substrate including:
a plurality of pixel parts disposed in the display region for displaying the image;
a plurality of photo sensing parts disposed in the display region for detecting the location of an object disposed on or immediately adjacent to a surface of the display panel; and,
a reflection preventing layer disposed in the peripheral region;
an upper substrate facing the lower substrate, the upper substrate including a black matrix corresponding to the peripheral region; and,
a liquid crystal layer interposed between the lower and upper substrates.

2. The display panel of claim 1, wherein the pixel parts comprise:
a gate line;
a data line electrically insulated from and crossing the gate line;
a first switching element electrically coupled to the gate line and the data line; and,
a transparent electrode electrically coupled to the first switching element.

3. The display panel of claim 2, wherein:
the lower substrate further comprises a reflection electrode electrically coupled to the transparent electrode, and
the reflection electrode includes a transmission window through which light is transmitted.

4. The display panel of claim 3, wherein the reflection preventing layer comprises substantially the same material and is formed in substantially the same layer as the reflection electrode.

5. The display panel of claim 2, wherein the peripheral region comprises:
a first peripheral portion on which an input terminal of the data line is disposed;
a second peripheral portion on which an input terminal of the gate line is disposed; and,
a third peripheral portion disposed adjacent to the first and second peripheral portions.

6. The display panel of claim 5, wherein the reflection preventing layer in the first peripheral portion comprises substantially the same material and is formed in substantially the same layer as the gate line.

7. The display panel of claim 6, wherein the reflection preventing layer in the first peripheral portion is spaced apart from the data line.

8. The display panel of claim 5, wherein the reflection preventing layer in the second peripheral portion comprises substantially the same material and is formed in substantially the same layer as the data line.

9. The display panel of claim 8, wherein the reflection preventing layer in the second peripheral portion is spaced apart from the gate line.

10. The display panel of claim 5, wherein the reflection preventing layer in the third peripheral portion comprises substantially the same material and is formed in substantially the same layer as one of either the gate line or the data line.

11. The display panel of claim 1, wherein the photo sensing parts comprises:
a first sensing line;
a second sensing line electrically insulated from and crossing the first sensing line;
a second switching element electrically connected to the first sensing line to output a sensing signal in response to the incidence of light thereon; and,
a third switching element that applies the sensing signal from the second switching element to the second sensing line.

12. The display panel of claim 1, wherein the upper substrate further comprises:
a color filter layer corresponding to the display region; and,
a common electrode disposed on the color filter layer.

13. A display device, comprising:
a backlight assembly for generating a uniform field of light; and,
a display panel disposed on the backlight assembly for forming an image from the light generated by the backlight assembly and for displaying the image at an upper surface thereof, the panel including:
a lower substrate divided into a display region for displaying the image and a peripheral region disposed adjacent to the display region, the lower substrate including:
a plurality of pixel parts disposed in the display region for displaying the image; and,
a plurality of photo sensing parts disposed in the display region for detecting the location of an object disposed on or immediately adjacent to the upper surface of the display panel;
an upper substrate facing the lower substrate, the upper substrate including a black matrix corresponding to the peripheral region;
a liquid crystal layer interposed between the lower and upper substrates; and,
a reflection preventing layer disposed in the peripheral region such that light generated by the backlight assembly is prevented from reflecting back from the black matrix and onto the photo sensing parts.

14. The display device of claim 13, wherein the reflection preventing layer is disposed below the black matrix.

15. The display device of claim 13, wherein the pixel parts comprise:
a gate line;
a data line electrically insulated from and crossing the gate line;
a switching element electrically coupled to the gate and data lines; and,
a transparent electrode electrically coupled to the switching element.

16. The display device of claim 15, wherein the lower substrate further comprises a reflection electrode for reflecting light originating externally of the display, the reflecting electrode being electrically coupled to the transparent electrode and comprising substantially the same material as the reflection preventing layer.

17. The display device of claim 15, wherein:
the peripheral region comprises a first peripheral portion upon which an input terminal of the data line is disposed, and
the reflection preventing layer in the first peripheral portion comprises substantially the same material and is formed in substantially the same layer as the gate line.

18. The display device of claim 17, wherein:
the peripheral region further comprises a second peripheral portion on which an input terminal of the gate line is disposed, and
the reflection preventing layer in the second peripheral portion comprises substantially same material and is formed in substantially the same layer as the data line.

19. The display device of claim 18, wherein:
the peripheral region further comprises a third peripheral portion located adjacent to the first and second peripheral portions, and
the reflection preventing layer in the third peripheral portion comprises substantially the same material and is formed in substantially the same layer as one of either the gate line or the data line.
